(19) United States
(12) Patent Application Publication
(10) Pub. No.: US 2025/0274657 A1
(43) Pub. Date: Aug. 28, 2025

(54) ELECTRONIC DEVICE

(71) Applicant: CANON KABUSHIKI KAISHA, Tokyo (JP)

(72) Inventors: REMPEI MIYAGUCHI, Kanagawa (JP); SEIJI OGAWA, Tokyo (JP)

(21) Appl. No.: 19/041,085

(22) Filed: Jan. 30, 2025

(30) Foreign Application Priority Data
Feb. 27, 2024 (JP) 2024-027332

(51) Int. Cl. H04N 23/67; H04N 23/62; H04N 23/63; H04N 23/667

(52) U.S. Cl. CPC H04N 23/671; H04N 23/62; H04N 23/631; H04N 23/667; H04N 23/672

(57) ABSTRACT

An electronic device according to the present invention includes a processor, and a memory storing a program which, when executed by the processor, causes the electronic device to execute acquisition processing of acquiring information related to a line-of-sight position of a user, and execute control processing of performing control to display a screen and performing control to identifiably display an item corresponding to a focused position of the user on the screen based on the information related to the line-of-sight position, wherein, in a case where a layout of the screen is switched, in the control processing, regardless of a focused position of the user on the screen after the switching, control is performed so that an item that is identifiably displayed before the switching is identifiably displayed on the screen after the switching.

### BACKGROUND OF THE INVENTION

### Field of the Invention

The present invention relates to an electronic device and particularly to display of a screen.

### Description of the Related Art

JP 2007-102360 A discloses a technique of detecting a line-of-sight position of a user on a screen of an electronic book and displaying a part of interest of the user in the electronic book in a highlighted manner.

However, in the technique disclosed in JP 2007-102360 A, when the user takes his/her eyes off (deviates) the part of interest, the emphasis is released, and the part of interest may be missed.

### SUMMARY OF THE INVENTION

The present invention provides a technique capable of making it less likely for a user to miss a part that the user focuses on (pays attention to) in the past.

An electronic device according to the present invention includes a processor, and a memory storing a program which, when executed by the processor, causes the electronic device to execute acquisition processing of acquiring information related to a line-of-sight position of a user, and execute control processing of performing control to display a screen and performing control to identifiably display an item corresponding to a focused position of the user on the screen based on the information related to the line-of-sight position, wherein, in a case where a layout of the screen is switched, in the control processing, regardless of a focused position of the user on the screen after the switching, control is performed so that an item that is identifiably displayed before the switching is identifiably displayed on the screen after the switching.

Further features of the present invention will become apparent from the following description of exemplary embodiments with reference to the attached drawings.

### BRIEF DESCRIPTION OF THE DRAWINGS

FIGS. 1A and 1B are external views of a digital camera;

FIG. 2 is a block diagram of a digital camera;

FIGS. 3A to 3C are schematic diagrams of a display screen;

FIG. 4 is a flowchart of shooting mode processing according to a first embodiment; and

FIG. 5 is a flowchart of shooting mode processing according to a second embodiment.

### DESCRIPTION OF THE EMBODIMENTS

Hereinafter, embodiments of the present invention are described with reference to the drawings. In the present embodiment, a part of which a user focuses on (pays attention to) in the past is made less likely to be missed than before.

Due to the trend of a social networking service (SNS) vertical moving image corresponding to a screen of a smartphone and the like, as scenes where photographing is performed in a vertical position of a camera increase, scenes where photographing is performed while the vertical position and the horizontal position of the camera are frequently switched increase. Therefore, it is important to provide a comfortable user experience (UX) in both the vertical position and the horizontal position of the camera.

However, in a case where the layout of the screen is switched, for example, in a case where the displayed screen is instantaneously switched from the vertical screen to the horizontal screen (or from the horizontal screen to the vertical screen), the user may miss (not be able to immediately find) the item focused on before the switching. In the present embodiment, in such a case, it is less likely for the user to miss the item focused on before the switching.

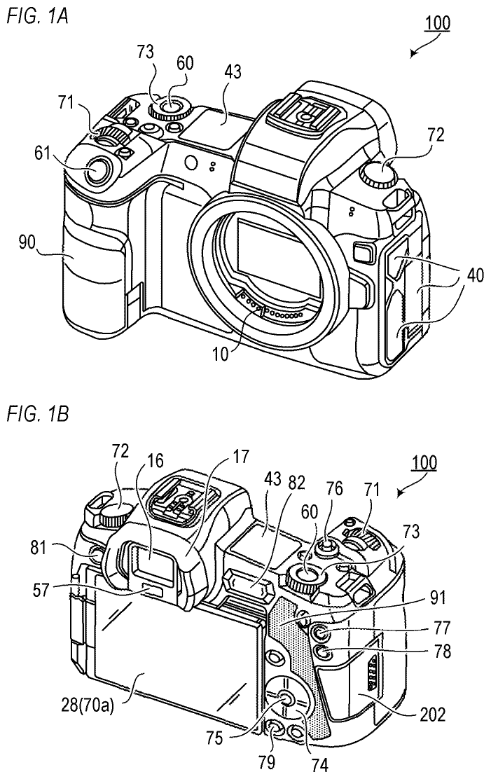

FIGS. 1A and 1B are external views of a digital camera 100 (imaging apparatus) as an example of a device (electronic device) to which the present invention can be applied. FIG. 1A is a front perspective view of the digital camera 100, and FIG. 1B is a rear perspective view of the digital camera 100.

A display unit 28 is a display unit provided on the back surface of the digital camera 100 and displays an image and various types of information. A touch panel 70a can detect a touch operation on a display surface (touch operation surface) of the display unit 28. An outer finder display unit 43 is a display unit provided on the upper surface of the digital camera 100 and displays various setting values of the digital camera 100 including a shutter speed and an aperture. A shutter button 61 is an operation member for giving a shooting instruction. A mode selector switch 60 is an operation member for switching among various modes. A terminal cover 40 is a cover that protects a connector (not illustrated) with a connection cable or the like that connects the digital camera 100 to an external device.

A main electronic dial 71 is a rotation operation member, and a setting value such as a shutter speed or an aperture can be changed by turning the main electronic dial 71. A power switch 72 is an operation member for switching between ON and OFF of power supply of the digital camera 100. A sub-electronic dial 73 is a rotation operation member, and movement of a selection frame (cursor), image feeding, and the like can be performed by turning the sub-electronic dial 73. A four-direction key 74 is configured to be able to press each of upper, lower, left, and right portions and can perform processing corresponding to a pressed portion of the four-direction key 74. A SET button 75 is a push button and is mainly used to determine a selection item.

A movie button 76 is used for an instruction to start or stop movie shooting (recording). An AE lock button 77 is a push button, and the exposure state can be fixed by pressing the AE lock button 77 in the shooting standby state. An enlargement button 78 is an operation button for switching ON or OFF of an enlargement mode in live view display (LV display) of a shooting mode. By turning on the enlargement mode and then operating the main electronic dial 71, the live view image (LV image) can be enlarged or reduced. In a playback mode, the enlargement button 78 functions as an operation button for enlarging a playback image or increasing an enlargement ratio. A playback button 79 is an operation member for switching the shooting mode and the playback mode. During the shooting mode, the mode shifts to the playback mode by pressing of the playback button 79, so that the latest one of images recorded in a recording medium 200 (described below) can be displayed on the display unit 28. A menu button 81 is a push button used to perform an instruction operation for displaying a menu screen, and a menu screen on which various settings can be performed is displayed on the display unit 28 when the menu button 81 is pressed. A user can perform various settings instinctively by using the menu screen displayed on the display unit 28, the four-direction key 74, and the SET button 75.

A touch bar 82 is a linear touch operation member (line touch sensor) that can receive a touch operation. The touch bar 82 is disposed at a position that enables a touch operation (touchable) with the thumb finger of the right hand in a state in which a grip portion 90 is gripped with the right hand (a state in which the grip portion 90 is gripped with the little finger, the ring finger, and the middle finger of the right hand) such that the shutter button 61 can be pressed by the index finger of the right hand. That is, the touch bar 82 is disposed at a position where the digital camera can be operated in a state in which the user approaches to an eyepiece viewfinder 17 with the eyes, looks through an eyepiece portion 16, and holds up the digital camera so as to be able to press a shutter button 61 at any time (shooting orientation). The touch bar 82 can receive a tapping operation on the touch bar 82 (an operation of touching the touch bar and releasing the touch bar without moving the touch position within a predetermined period of time), a sliding operation to the left or right (an operation of touching the touch bar and then moving the touch position while keeping the touch), and the like. The touch bar 82 is an operation member that is different from a touch panel 70a and does not have a display function. The touch bar 82 functions as, for example, a multi-function bar (M-Fn bar) to which various functions can be allocated.

A communication terminal 10 is a communication terminal that causes the digital camera 100 to perform communication with a lens unit 150 (described below; detachable) side. The eyepiece portion 16 is an eyepiece portion of the eyepiece viewfinder 17 (viewing-type finder), and the user can view a video displayed in an EVF 29 (described below; an electronic viewfinder) via the eyepiece portion 16. An eyepiece detection unit 57 is an eyepiece detection sensor which detects whether or not the user (photographer) approaches the eyepiece portion 16 with the eyes. A lid 202 is a lid of a slot that stores the recording medium 200 (described below). The grip portion 90 is a holding portion which is formed into a shape in which the user can easily grip the grip portion 90 with the right hand when holding up the digital camera 100. The shutter button 61 and the main electronic dial 71 are arranged at positions where the user can operate the shutter button 61 and the main electronic dial 71 with the index finger of the right hand in a state in which the user holds the digital camera 100 while gripping the grip portion 90 with the little finger, the ring finger, and the middle finger of the right hand. Also, in the same state, the sub-electronic dial 73 and the touch bar 82 are arranged at positions where the user can operate the sub-electronic dial 73 and the touch bar 82 with the thumb finger of the right hand. A thumb rest portion 91 (thumb standby position) is a grip portion provided at a place where it is easy for the user to place the thumb finger of the right hand that grips the grip portion 90 on the back side of the digital camera 100 in a state in which any of the operation members is not operated. The thumb rest portion 91 is configured with a rubber member for enhancing the holding power (gripping feeling).

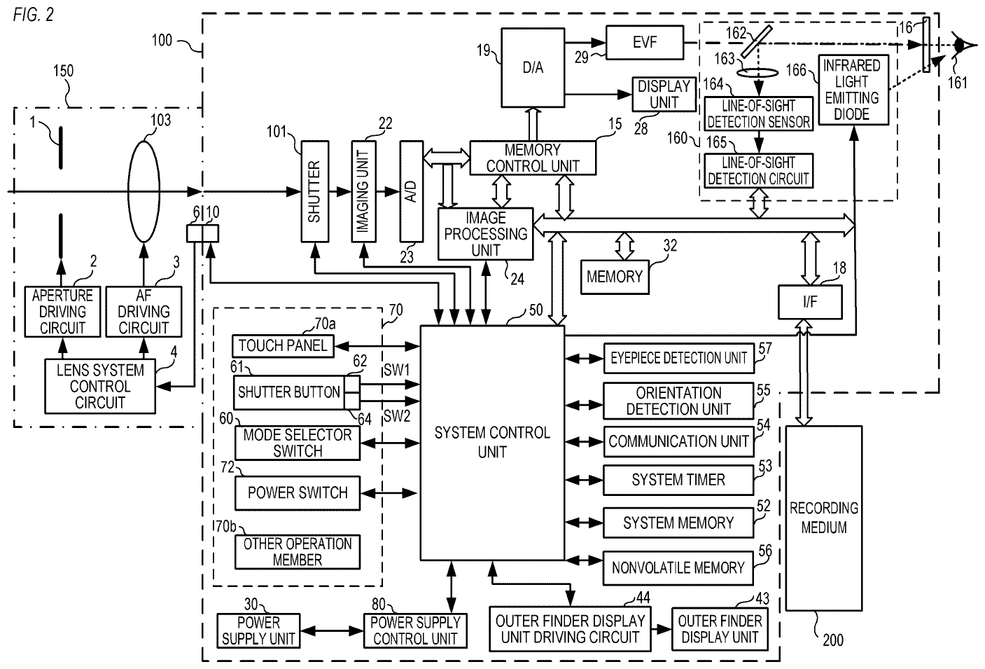

FIG. 2 is a block diagram illustrating a configuration example of the digital camera 100. The lens unit 150 is a lens unit equipped with an interchangeable imaging lens. A lens 103 is usually configured with a plurality of lenses, but FIG. 2 illustrates only one lens in a simplified manner. A communication terminal 6 is a communication terminal that causes the lens unit 150 to communicate with the digital camera 100 side, and the communication terminal 10 is a communication terminal that causes the digital camera 100 to communicate with the lens unit 150 side. The lens unit 150 communicates with a system control unit 50 via the communication terminals 6 and 10. Then, the lens unit 150 controls an aperture 1 via an aperture driving circuit 2 by a lens system control circuit 4. Further, the lens unit 150 adjusts the focus by changing the position of the lens 103 via an AF driving circuit 3 by the lens system control circuit 4.

A shutter 101 is a focal plane shutter that can freely control the exposure time of an imaging unit 22 under the control of the system control unit 50.

The imaging unit 22 is an imaging element (image sensor) configured with a CCD, a CMOS element, or the like that converts an optical image into an electrical signal. The imaging unit 22 may include an imaging-surface phase-difference sensor for outputting defocus-amount information to the system control unit 50. An A/D converter 23 converts an analog signal output from the imaging unit 22 into a digital signal.

An image processing unit 24 performs predetermined processing (such as pixel interpolation, resizing processing referred to as reduction, and color conversion processing) on data from an A/D converter 23 or data from a memory control unit 15. In addition, the image processing unit 24 performs predetermined arithmetic processing by using captured image data, and the system control unit 50 performs exposure control and distance measurement control based on a calculation result obtained by the image processing unit 24. As a result, through-the-lens (TTL)-type autofocus (AF) processing, auto exposure (AE) processing, flash pre-flash (EF) processing, and the like are performed. Furthermore, the image processing unit 24 performs predetermined arithmetic processing by using the captured image data and performs TTL-type auto white balance (AWB) processing based on the obtained calculation result.

The memory control unit 15 controls transmission and reception of data among the A/D converter 23, the image processing unit 24, and a memory 32. Output data from the A/D converter 23 is written into the memory 32 via the image processing unit 24 and the memory control unit 15. Alternatively, the output data from the A/D converter 23 is written into the memory 32 via the memory control unit 15 without the image processing unit 24. The memory 32 stores the image data that is obtained by the imaging unit 22 and is converted into digital data by the A/D converter 23 and image data to be displayed on the display unit 28 or the EVF 29. The memory 32 has a storage capacity that is sufficient for storing a predetermined number of still images and movie and voice in a predetermined period of time.

In addition, the memory 32 also serves as a memory (video memory) for image display. A D/A converter 19 converts image data for display stored in the memory 32 into an analog signal and supplies the analog signal to the display unit 28 or the EVF 29. Thus, the image data for display that is written into the memory 32 is displayed by the display unit 28 or the EVF 29 via the D/A converter 19. Each of the display unit 28 and the EVF 29 is a display such as an LCD or an organic EL and performs display corresponding to an analog signal from the D/A converter 19. Digital signals that are A/D converted by the A/D converter 23 and are accumulated in the memory 32 are converted into an analog signal in the D/A converter 19, and the analog signals are sequentially transferred to and displayed on the display unit 28 or the EVF 29, whereby live view display (LV) can be performed. Hereinafter, an image displayed in live view display is referred to as a live view image (LV image).

The system control unit 50 is a control unit including at least one processor and/or at least one circuit and controls the entire digital camera 100. The system control unit 50 is a processor and also a circuit. The system control unit 50 implements each piece of processing of the present embodiment described below, by executing programs recorded in a nonvolatile memory 56. In addition, the system control unit 50 also performs display control by controlling the memory 32, the D/A converter 19, the display unit 28, the EVF 29, and the like.

A system memory 52 is, for example, a RAM, and the system control unit 50 loads constants, variables, programs read from the nonvolatile memory 56, and the like for an operation of the system control unit 50 into the system memory 52.

The nonvolatile memory 56 is an electrically erasable and recordable memory and is, for example, an EEPROM. In the nonvolatile memory 56, constants for operations of the system control unit 50, programs, and the like are recorded. The programs as used herein are programs for executing various flowcharts described below according to the present embodiment.

A system timer 53 is a timer unit that counts time used for various controls and time of a built-in clock.

A communication unit 54 transmits and receives a video signal and a voice signal to and from an external device connected thereto wirelessly or via a wired cable. The communication unit 54 is also connectable to a wireless local area network (LAN) and the Internet. In addition, the communication unit 54 can communicate with an external device also via Bluetooth (registered trademark) or Bluetooth Low Energy. The communication unit 54 can transmit an image captured by the imaging unit 22 (including an LV image) and an image recorded in the recording medium 200 and can receive image data and other various types of information from an external device.

An orientation detection unit 55 detects the orientation of the digital camera 100 with respect to the direction of gravity. Based on the orientation detected by the orientation detection unit 55, whether an image shot by the imaging unit 22 is an image shot with the digital camera 100 held in a horizontal position or an image shot with the digital camera 100 held in a vertical position can be determined. The system control unit 50 can add direction information corresponding to the orientation detected by the orientation detection unit 55 to an image file of the image captured by the imaging unit 22 or rotate and record the image. For example, an acceleration sensor, a gyro sensor, or the like can be used as the orientation detection unit 55. It is also possible to detect movement of the digital camera 100 (whether or not the digital camera 100 is panning, tilting, rolling, lifting, stationary, or the like) by using an acceleration sensor or a gyro sensor which is the orientation detection unit 55.

The eyepiece detection unit 57 is an eyepiece detection sensor that detects approach (eye approach) and separation (eye separation) of an eye (object) 161 (approach detection) with respect to the eyepiece portion 16 of the eyepiece viewfinder 17 (hereinafter, simply referred to as a “finder”). The system control unit 50 switches between display (display state) and non-display (non-display state) of each of the display unit 28 and the EVF 29 according to the state detected by the eyepiece detection unit 57. Specifically, in a case where at least the shooting standby state is established, and a switching setting for a display destination is set to automatic switching, while an eye is not approached, the display is turned on with the display destination set as the display unit 28, and the EVF 29 does not perform display. In addition, while an eye is approached, the display is turned on with the display destination set as the EVF 29, and the display unit 28 does not perform display. For example, an infrared proximity sensor can be used as the eyepiece detection unit 57, and it is possible to detect the approach of any object to the eyepiece portion 16 of the finder 17 incorporating the EVF 29. When an object approaches, infrared light emitted from a light-emitting portion (not illustrated) of the eyepiece detection unit 57 is reflected on the object and is received by a light-receiving portion (not illustrated) of an infrared proximity sensor. The distance to which the object approaches from the eyepiece portion 16 (eye approach distance) can also be determined by the amount of the received infrared light. In this way, the eyepiece detection unit 57 performs eye approach detection which detects an approach distance of the object to the eyepiece portion 16. In the case where an object which approaches within a predetermined distance of the eyepiece portion 16 is detected in a non-eye approach state (non-approach state), it is detected that the eye approaches. In a case where the object of which the approach is detected is separated from the eyepiece portion 16 by a predetermined distance or longer in an eye approach state (approach state), it is detected that the eye is separated. The threshold value for detecting the eye approach and the threshold value for detecting the eye separation may be different by providing, for example, a hysteresis. After the eye approach is detected, the eye approach state is assumed until the eye separation is detected. After the eye separation is detected, the non-eye approach state is assumed until the eye approach is detected. Note that the infrared proximity sensor is an example, and other sensors may be adopted as the eyepiece detection unit 57 as long as the sensors can detect a state that can be regarded as the eye approach.

Various setting values of the camera including the shutter speed and the aperture are displayed on the outer finder display unit 43 via an outer finder display unit driving circuit 44.

A power supply control unit 80 includes a battery detection circuit, a DC-DC converter, a switch circuit that switches a block to be energized, and the like, and detects whether or not a battery is mounted, the type of battery, a remaining battery level, and the like. In addition, the power supply control unit 80 controls the DC-DC converter on the basis of a result of the detection and an instruction from the system control unit 50, and supplies a required voltage to portions including the recording medium 200 for a necessary period of time. A power supply unit 30 is a primary battery such as an alkaline battery or a lithium battery, a secondary battery such as a NiCd battery, a NiMH battery, or a lithium ion battery, an AC adapter, or the like.

A recording medium I/F 18 is an interface with the recording medium 200 such as a memory card or a hard disk. The recording medium 200 is a recording medium such as a memory card for recording a shot image and is configured with a semiconductor memory and a magnetic disk.

An operation unit 70 is an input unit that receives an operation from a user (user operation) and is used for inputting various operation instructions to the system control unit 50. As illustrated in FIG. 2, the operation unit 70 includes the shutter button 61, the mode selector switch 60, the power switch 72, the touch panel 70a, other operation members 70b, and the like. The other operation members 70b include the main electronic dial 71, the sub-electronic dial 73, the four-direction key 74, the SET button 75, the movie button 76, the AE lock button 77, the enlargement button 78, the playback button 79, the menu button 81, the touch bar 82, and the like.

The shutter button 61 includes a first shutter switch 62 and a second shutter switch 64. The first shutter switch 62 is turned on in the middle of an operation of the shutter button 61 in response to so-called half-press (shooting preparation instruction) and generates a first shutter switch signal SW1. The system control unit 50 starts a shooting preparation operation such as autofocus (AF) processing, automatic exposure (AE) processing, automatic white balance (AWB) processing, or flash pre-flash (EF) processing with the first shutter switch signal SW1. The second shutter switch 64 is turned on at completion of the operation of the shutter button 61 in response to so-called full-press (shooting instruction) and generates a second shutter switch signal SW2. The system control unit 50 starts a series of shooting processing operations from reading a signal from the imaging unit 22 to writing a captured image as an image file into the recording medium 200 with the second shutter switch signal SW2.

The mode selector switch 60 switches an operation mode of the system control unit 50 to any of a still image photographing mode, a movie shooting mode, and a playback mode. Examples of the still image shooting mode include an auto shooting mode, an auto scene determination mode, a manual mode, an aperture-priority mode (Av mode), a shutter-speed priority mode (Tv mode), and a program AE mode (P mode). In addition, examples thereof also include various scene modes and custom modes serving as shooting settings for each shooting scene. A user can directly switch the operation mode to any one of these modes with the mode selector switch 60. Alternatively, the user may temporarily switch a screen to a list screen of a shooting mode with the mode selector switch 60 and then selectively switch the mode to any one of the plurality of displayed modes with another operation member. Similarly, the movie shooting mode may include a plurality of modes.

The touch panel 70a is a touch sensor that detects various touch operations on a display surface of the display unit 28 (an operation surface of the touch panel 70a). The touch panel 70a and the display unit 28 can be integrally configured. For example, the touch panel 70a is configured so that a transmittance of light does not hinder display on the display unit 28 and is attached to an upper layer of the display surface of the display unit 28. Then, input coordinates on the touch panel 70a are associated with display coordinates on the display surface of the display unit 28. As a result, it is possible to provide a graphical user interface (GUI) configured as if the user can directly operate a screen displayed on the display unit 28.

A line-of-sight detection block 160 (eye tracking unit, eye tracker) is a block for detecting whether the user whose eye approaches the eyepiece portion 16 is looking at the EVF 29 or a line of sight indicating which position the user is looking at when the user is looking at the EVF 29. The line-of-sight detection block 160 includes a dichroic mirror 162, an imaging lens 163, a line-of-sight detection sensor 164, an infrared light emitting diode 166, and a line-of-sight detection circuit 165.

The infrared light emitting diode 166 is a light-emitting element and irradiates the eyeball (eye) 161 of the user whose eye approaches eyepiece portion 16 with infrared light. Infrared light emitted from the infrared light emitting diode 166 is reflected on the eyeball (eye) 161, and the infrared reflected light reaches the dichroic mirror 162. The dichroic mirror 162 reflects only infrared light and transmits visible light. The infrared reflected light of which an optical path is changed forms an image on the imaging surface of the line-of-sight detection sensor 164 via the imaging lens 163. The imaging lens 163 is an optical member configuring a line-of-sight detection optical system. The line-of-sight detection sensor 164 includes an imaging device such as a CCD image sensor. The line-of-sight detection sensor 164 photoelectrically converts the incident infrared reflected light into an electrical signal and outputs the electrical signal to the line-of-sight detection circuit 165. The line-of-sight detection circuit 165 includes at least one processor, detects a line-of-sight position of the user from an image or movement of eyeball (eye) 161 of the user based on an output signal of the line-of-sight detection sensor 164, and outputs detection information to the system control unit 50.

In the present embodiment, the line-of-sight detection block 160 is used to detect the line of sight by a method referred to as a corneal reflection method. The corneal reflection method is a method of detecting the direction and position of the line of sight from the positional relationship between the reflected light obtained by reflecting the infrared light emitted from the infrared light emitting diode 166 by the eyeball (eye) 161 (particularly the cornea) and the pupil of the eyeball (eye) 161. In addition, there is a method of detecting various directions and positions of the line of sight, such as a method called a scleral reflection method using a difference in light reflectance between the iris and the white of the eye. Note that a line-of-sight detection method other than the above may be used as long as the method can detect the direction and position of the line of sight. In the present embodiment, the description has been given assuming that the light-emitting portion and the light-receiving portion of the eyepiece detection unit 57 are separate devices from the infrared light emitting diode 166 and the line-of-sight detection sensor 164 described above. However, the present invention is not limited thereto, and the light-emitting portion of the eyepiece detection unit 57 may also serve as the infrared light emitting diode 166, and the light-receiving portion may also serve as the line-of-sight detection sensor 164.

The system control unit 50 can detect the following operation or state based on the output from the line-of-sight detection block 160.
The line of sight of the user whose eye approaches the eyepiece portion 16 is newly input (detected). That is, the start of line-of-sight input.
There is line-of-sight input of the user whose eye approaches the eyepiece portion 16.
A state in which the user whose eye approaches the eyepiece portion 16 is gazing.
The line of sight input by the user whose eye approaches the eyepiece portion 16 is removed. That is, the end of line-of-sight input.
A state in which the user whose eye approaches eyepiece portion 16 inputs no line of sight.

The gaze described herein means that the user is continuously gazing at substantially the same position over a certain period of time. In the determination on whether or not the user is gazing, for example, in a case where the line-of-sight position of the user does not exceed a predetermined movement amount for a predetermined period of time (for example, about 0.5 seconds), it is determined that the user is gazing. Note that the predetermined period of time may be time that can be set by the user, may be time fixed and determined in advance, or may be changed depending on a distance relationship between the previous line-of-sight position and the current line-of-sight position. For example, based on the detection information acquired from the line-of-sight detection circuit 165, the system control unit 50 determines that the user is gazing when the duration time of a state in which the line of sight of the user is detected at substantially the same position (state of no movement of the line of sight) exceeds a predetermined period of time (threshold period). In addition, for example, in a case where the average position of detection positions of the line of sight for a short period (≤the above-described threshold period) including the latest detection timing falls within a predetermined range, and a variation (variance) is smaller than a predetermined value, the system control unit 50 determines that it is a state of no movement of the line of sight.

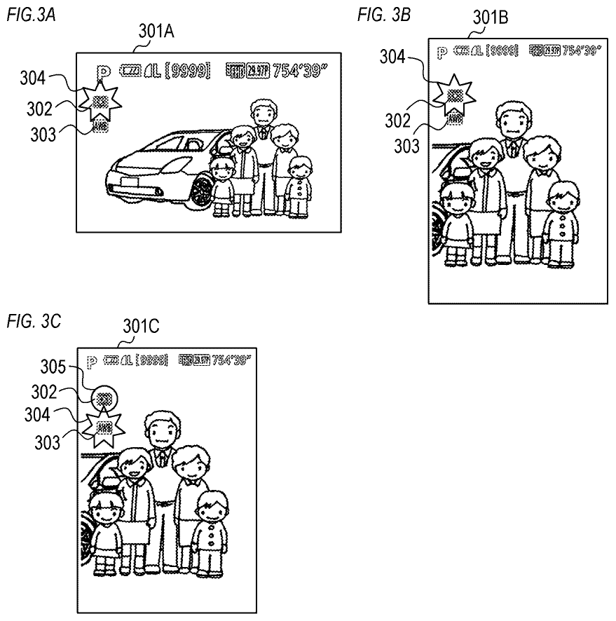

FIGS. 3A to 3C are schematic diagrams illustrating an example of a screen displayed on the EVF 29. FIG. 3A illustrates a screen when the orientation of the digital camera 100 is the horizontal position (when the user holds the digital camera 100 horizontally). FIGS. 3B and 3C illustrate a screen when the orientation of the digital camera 100 is the vertical position (when the user holds the digital camera 100 vertically).

A screen 301A (horizontal screen) of FIG. 3A includes icons 302 and 303. Similarly, screens 301B and 301C (vertical screens) in FIGS. 3B and 3C also include the icons 302 and 303. The layout of the screen is different between the horizontal screen 301A and the vertical screens 301B and 301C, and the display positions of the icons 302 and 303 are different. Therefore, when the screen is switched from the horizontal screen to the vertical screen (or from the vertical screen to the horizontal screen), the user may miss (not be able to immediately find) an item focused before the switching.

Therefore, in the present embodiment, the system control unit 50 performs control to identifiably display an item corresponding to the focused position of the user on the screen based on the line-of-sight information (information related to the line-of-sight position, information based on detection of the line-of-sight detection circuit 165). Then, when the layout of the screen is switched, the system control unit 50 performs control so that the item that has been identifiably displayed before the switching is identifiably displayed on the screen after the switching, regardless of the focused position of the user on the screen after the switching.

By identifiably displaying the item that has been identifiably displayed before the switching on the screen after the switching, it is possible to cause the user to be less likely to miss the item focused before the switching.

On the screen after the switching, the system control unit 50 identifiably displays the first item that has been identifiably displayed before the switching but may perform control not to identifiably display a second item corresponding to a new focused position of the user. The first item and the second item are different.

For example, when the user sets the orientation of the digital camera 100 to be the horizontal position and focuses on the icon 302 on the horizontal screen 301A, highlight display 304 of the icon 302 is started under the control of the system control unit 50. Also, when the user changes the orientation of the digital camera 100 from the horizontal position to the vertical position, the screen displayed on the EVF 29 transitions from the horizontal screen 301A to the vertical screen 301B under the control of the system control unit 50. On the vertical screen 301B, even when the user deviates the line of sight from the icon 302, the highlight display 304 of the icon 302 is continued. At this time, even if the user directs the line of sight to the icon 303, highlight display of the icon 303 is not performed.

By not identifiably displaying the item of the new focused position, the screen becomes simple (complication of the screen is suppressed), and it is more likely for the user to find the focused item before switching.

On the screen after the switching, the system control unit 50 identifiably displays the first item that has been identifiably displayed before the switching in a first form but may perform control to identifiably display a second item corresponding to a new focused position of the user in a second form. The first item and the second item are different, and thus the first form and the second form are different.

For example, when the user changes the orientation of the digital camera 100 from the vertical position to the horizontal position, the screen displayed on the EVF 29 transitions from the horizontal screen 301A to the vertical screen 301C under the control of the system control unit 50. On the vertical screen 301C, the highlight display of the icon 302 that has been focused on before the switching is changed from the highlight display 304 to highlight display 305, and the highlight display 304 is performed as the highlight display of the newly focused icon 302. Note that in the vertical screen, the highlight display 304 of the icon 302 may be continued, and the highlight display 305 of the icon 303 may be started.

By identifiably displaying the item that has been identifiably displayed before the switching and the item at the new focused position in different forms, it is more likely for the user to find the item has been focused before the switching, and it is more likely to recognize the currently focused item.

The control of identifiably displaying the item includes, for example, at least one of the following controls.
Control to enlarge item
Control to change color of item (for example, addition of a predetermined tint, inversion of color, or change of color tone)
Control to blink item
Control of changing speed of display change of item (in an icon (animation icon) with change (motion, blinking, size change, color change), change rate of change)

In order to suppress complication of the screen, the item may not be displayed when the user is not looking, and the item may be displayed when the user is looking. Therefore, the control to make the item identifiable may include control to display an item not displayed.

In consideration of difficulty in finding the item based on the size or the display position of the item, the system control unit 50 may determine whether or not to identifiably display the item that has been identifiably displayed before the switching on the screen after the switching. For example, in a case where the size of the item identifiably displayed before the switching is smaller than the threshold value on the screen after the switching, it may be determined that the item is not identifiably displayed on the screen after the switching. In a case where the position corresponding to the item identifiably displayed before the switching is within a predetermined area (for example, an end portion of the screen) on the screen after the switching, it may be determined that the item is not identifiably displayed on the screen after the switching.

The above-described focused position may be a line-of-sight position (instantaneous value) or an attention position (statistical value). For example, the focused position may be a position where the line-of-sight position is maintained for a predetermined period of time.

### First Embodiment

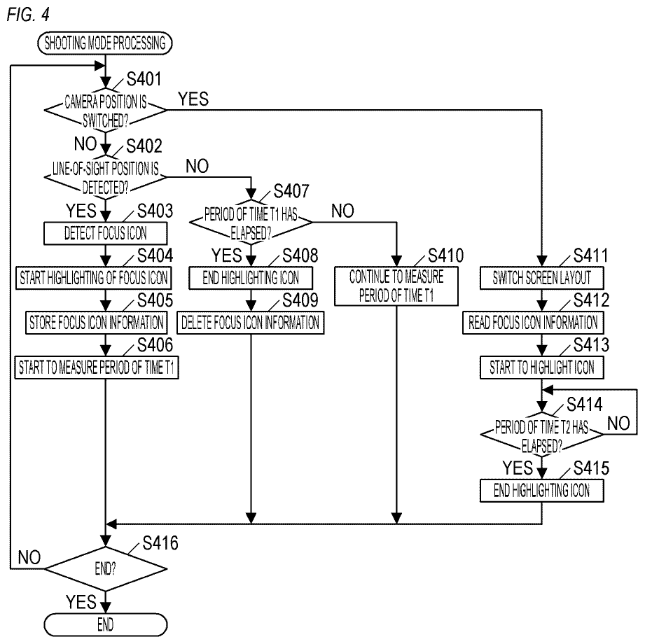

A first embodiment of the present invention is described. FIG. 4 is a flowchart illustrating shooting mode processing according to the first embodiment. The shooting mode processing in FIG. 4 is implemented by the system control unit 50 loading a program stored in the nonvolatile memory 56 into the system memory 52 and executing the program. For example, when a shooting mode is set, the system control unit 50 starts the shooting mode processing of FIG. 4. Note that, in FIG. 4, a plurality of operations such as a shooting preparation operation and shooting processing operation are omitted. The present embodiment is not limited only to the shooting mode, the same operation as that in FIG. 4 may be performed in various scenes.

In S401, the system control unit 50 determines whether or not the camera position is switched (switch from the horizontal position to the vertical position, or switch from the vertical position to the horizontal position) based on the output signal of the orientation detection unit 55. When it is determined that the camera position is switched, the process proceeds to S411, and otherwise, the process proceeds to S402.

In S402, the system control unit 50 determines whether or not the line-of-sight position of the user is detected based on the line-of-sight information (information related to the line-of-sight position and detection information of the line-of-sight detection circuit 165). When it is determined that the line-of-sight position is detected, the process proceeds to S403, and otherwise, the process proceeds to S407.

In S403, the system control unit 50 determines a focused position of the user based on the line-of-sight information and detects an icon (the icon displayed at the focused position or the icon displayed at the focused position) corresponding to the focused position. Hereinafter, the icon corresponding to the focused position is referred to as a focus icon.

In S404, the system control unit 50 starts highlight display of the focus icon detected in S403. Note that, in a case where there is an icon already subjected to highlight display, the highlight display of the icon is stopped, and the highlight display of a new focus icon is started.

In S405, the system control unit 50 stores, in the system memory 52, the information on the focus icon (the focus icon information) for which highlight display is started in S404. Note that when the focus icon information is already stored in the system memory 52, the focus icon information stored in the system memory 52 is updated.

In step S406, in order to continue the highlight display of the icon for a predetermined period of time T1, the system control unit 50 starts to measure the period of time T1 using the system timer 53.

When it is determined that the line-of-sight position is detected in S402, the system control unit 50 determines whether or not the period of time T1 has elapsed from the highlight display in S404 in S407. When it is determined that the period of time T1 has elapsed, the process proceeds to S408, and otherwise, the process proceeds to S410.

In S408, the system control unit 50 ends the highlight display of the icon. In S409, the system control unit 50 deletes the focus icon information from the system memory 52.

In S410, the system control unit 50 continues to measure the period of time T1.

When it is determined that the camera position has been switched in S401, the system control unit 50 switches the screen direction (screen layout) (switch from the vertical screen to the horizontal screen, or switch from the horizontal screen to the vertical screen) in S411.

In S412, the system control unit 50 reads the focus icon information from the system memory 52.

In step S413, the system control unit 50 starts to perform highlight display the icon indicated by the focus icon information read in step S412 (the icon subjected to highlight display before the switching in step S411). At this time, in order to continue the highlight display of the icon for a predetermined period of time T2, the system control unit 50 starts to measure the period of time T2 using the system timer 53. The period of time T2 may be equal to the period of time T1 or may be longer or shorter than the period of time T1.

In S414, the system control unit 50 determines whether or not the period of time T2 has elapsed from the highlight display in S413. The process waits for the lapse of the period of time T2, and when it is determined that the period of time T2 has elapsed, the process proceeds to S415. When the camera position is switched while the period of time T2 is measured, the process proceeds to S411.

In S415, the system control unit 50 ends the highlight display of the icon.

In S416, the system control unit 50 determines whether or not an end of the shooting mode processing has been instructed. When it is determined that the end of the shooting mode processing is instructed, the shooting mode processing is ended, and otherwise, the process proceeds to S401. For example, in a case where the mode selector switch 60 is operated, that is, in a case where switching to another operation mode is instructed, the system control unit 50 determines that the end of the shooting mode processing has been instructed. In addition, in a case where the power switch 72 is operated, that is, in a case where it is instructed to turn on the power supply of the digital camera 100, the system control unit 50 determines that the end of the shooting mode processing is instructed.

### Second Embodiment

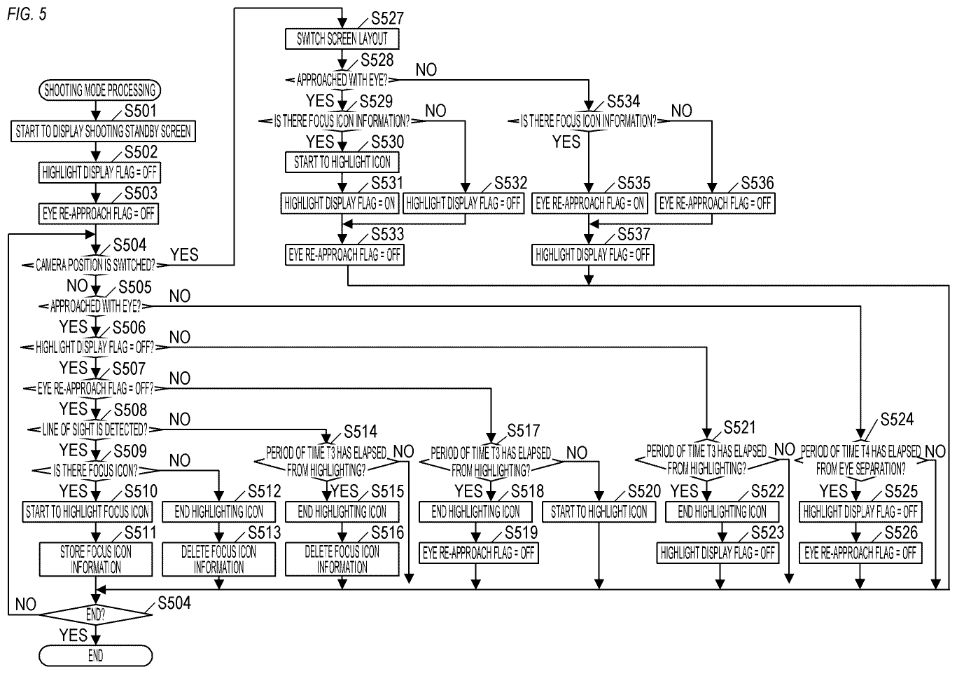

A second embodiment of the present invention is described. FIG. 5 is a flowchart illustrating shooting mode processing according to the second embodiment. The shooting mode processing in FIG. 5 is implemented by the system control unit 50 loading a program stored in the nonvolatile memory 56 into the system memory 52 and executing the program. For example, when a shooting mode is set, the system control unit 50 starts the shooting mode processing of FIG. 5. Note that, in FIG. 5, a plurality of operations such as a shooting preparation operation and shooting processing operation are omitted. The present embodiment is not limited only to the shooting mode, the same operation as that in FIG. 5 may be performed in various scenes.

In S501, the system control unit 50 starts to display the shooting standby screen.

In S502, the system control unit 50 performs the setting to an OFF state of a highlight display fixing flag that is an ON state in case of being continued before the switching of the highlight display after switching the layout and that is OFF on the other cases.

In S503, the system control unit 50 performs the setting to an OFF state of an eye re-approach flag that is in an ON state in case of waiting for the eye approach of the user and that is in an OFF state in other cases.

In S504, the system control unit 50 determines whether or not the camera position is switched (switch from the horizontal position to the vertical position, or switch from the vertical position to the horizontal position) based on the output signal of the orientation detection unit 55. When it is determined that the camera position is switched, the process proceeds to S527, and otherwise, the process proceeds to S505.

In S505, the system control unit 50 determines whether or not the user approaches the eyepiece portion 16 with an eye based on the output signal of the eyepiece detection unit 57. When it is determined that the user approaches the eyepiece portion 16 with an eye, the process proceeds to S506, and otherwise, the process proceeds to S524.

In S506, the system control unit 50 determines whether or not the highlight display fixing flag is in an OFF state. When it is determined that the highlight display fixing flag is in an OFF state, the process proceeds to S507, and otherwise, the process proceeds to S521.

In S507, the system control unit 50 determines whether or not the eye re-approach flag is in an OFF state. When it is determined that the eye re-approach flag is in an OFF state, the process proceeds to S508, and otherwise, the process proceeds to S517.

In S508, the system control unit 50 determines whether or not the line-of-sight position of the user is detected based on the line-of-sight information (information related to the line-of-sight position and detection information of the line-of-sight detection circuit 165). When it is determined that the line-of-sight position is detected, the process proceeds to S509, and otherwise, the process proceeds to S514.

In S509, the system control unit 50 determines the focused position of the user based on the line-of-sight information and determines whether or not there is a focus icon. When it is determined that there is a focus icon, the process proceeds to S510, and otherwise, the process proceeds to S512.

In S510, the system control unit 50 starts highlight display of the focus icon detected in S509. In S511, the system control unit 50 stores, in the system memory 52, the information on the focus icon (the focus icon information) for which highlight display is started in S510.

In S512, the system control unit 50 ends the highlight display of the icon. In S513, the system control unit 50 deletes the focus icon information from the system memory 52.

When it is determined that the line-of-sight position is detected in S508, the system control unit 50 determines whether or not a predetermined period of time T3 has elapsed from the start of the highlight display currently being performed in S514. The period of time T3 corresponds to the periods of time T1 and T2 of the first embodiment. When it is determined that the period of time T3 has elapsed, the process proceeds to S515, and otherwise, the process proceeds to S538.

In S515, the system control unit 50 ends the highlight display of the icon. In S516, the system control unit 50 deletes the focus icon information from the system memory 52.

When it is determined in S507 that the eye re-approach flag is in an ON state, in S517, the system control unit 50 determines whether or not the period of time T3 has elapsed from the start of the highlight display currently being performed. When it is determined that the period of time T3 has elapsed, the process proceeds to S518, and otherwise, the process proceeds to S520.

In S518, the system control unit 50 ends the highlight display of the icon. In S519, the system control unit 50 performs setting to an OFF state of the eye re-approach flag.

In S520, the system control unit 50 reads the focus icon information from the system memory 52 and starts highlight display of the icon indicated by the focus icon information. When the highlight display of the icon indicated by the focus icon information has already been performed, the highlight display is continued.

When it is determined in S506 that the highlight display fixing flag is in an ON state, in S521, the system control unit 50 determines whether or not the period of time T3 has elapsed from the start of the highlight display currently being performed. When it is determined that the period of time T3 has elapsed, the process proceeds to S522, and otherwise, the process proceeds to S538.

In S522, the system control unit 50 ends the highlight display of the icon. In S523, the system control unit 50 performs setting to an OFF state of the highlight display fixing flag.

In a case where it is determined in S505 that the user does not approach the eyepiece portion 16 with an eye, the system control unit 50 determines in S524 whether or not a predetermined period of time T4 has elapsed from the time when the eye is separated from the eyepiece portion 16. When it is determined that the period of time T4 has elapsed, the process proceeds to S525, and otherwise, the process proceeds to S538. The period of time T4 may be equal to the period of time T3 or may be longer or shorter than the period of time T3.

In S525, the system control unit 50 performs setting to an OFF state of the highlight display fixing flag. In S526, the system control unit 50 performs setting to an OFF state of the eye re-approach flag.

When the eye separation time is long, the process proceeds to S508 after the eye is separated from the eyepiece portion 16 by S524 to S526. As a result, the icon subjected to the highlight display in the past is not performed, and highlight display of a new focus icon is performed.

When it is determined that the camera position has been switched in S504, the system control unit 50 switches the screen direction (screen layout) (switch from the vertical screen to the horizontal screen, or switch from the horizontal screen to the vertical screen) in S527.

In S528, the system control unit 50 determines whether or not the user approaches the eyepiece portion 16 with an eye based on the output signal of the eyepiece detection unit 57. When it is determined that the user approaches the eyepiece portion 16 with an eye, the process proceeds to S529, and otherwise, the process proceeds to S534.

In S529, the system control unit 50 determines whether or not the focus icon information is stored in the system memory 52. When the focused icon information is stored, the process proceeds to S530, and otherwise, the process proceeds to S532.

In S530, the system control unit 50 reads the focus icon information from the system memory 52 and starts highlight display of the icon indicated by the focus icon information. In S531, the system control unit 50 performs setting to an ON state of the highlight display fixing flag.

By S504, S527 to S531, S506, and S521 to S523, when the user switches the camera position in the state of approaching the eyepiece portion 16 with an eye, the highlight display of the icon is performed for the period of time T3.

In S532, the system control unit 50 performs setting to an OFF state of the highlight display fixing flag.

In S533, the system control unit 50 performs setting to an OFF state of the eye re-approach flag.

When it is determined in S528 that eye approach is not performed, it is determined in S534 whether or not the focused icon information is stored in the system memory 52. When the focus icon information is stored, the process proceeds to S535, and otherwise, the process proceeds to S536.

In S535, the system control unit 50 performs setting to an ON state of the eye re-approach flag.

By S504, S527, S528, S534, S535, S507, and S517 to S520, when the user switches the camera position in the state of not approaching the eyepiece portion 16 with an eye, the highlight display of the icon is performed for the period of time T3 after the eye approaches to the eyepiece portion 16.

In S536, the system control unit 50 performs setting to an OFF state of the eye re-approach flag.

In S537, the system control unit 50 performs setting to an OFF state of the highlight display fixing flag.

In S538, the system control unit 50 determines whether or not an end of the shooting mode processing has been instructed. When it is determined that the end of the shooting mode processing is instructed, the shooting mode processing is ended, and otherwise, the process proceeds to S504.

Note that the above-described various types of control may or may not be performed by one piece of hardware (for example, a processor or a circuit). A plurality of pieces of hardware (for example, a plurality of processors, a plurality of circuits, or a combination of one or more processors and one or more circuits) may share processing to control the entire device.

Also, the above processor is a processor in a broad sense and includes a general-purpose processor and a dedicated processor. The general-purpose processor is, for example, a central processing unit (CPU), a micro processing unit (MPU), or a digital signal processor (DSP). The dedicated processor is, for example, a graphics processing unit (GPU), an application specific integrated circuit (ASIC), or a programmable logic device (PLD). The programmable logic device is, for example, a field programmable gate array (FPGA) or a complex programmable logic device (CPLD).

The present invention is specifically described in accordance with the preferred embodiments, but the present invention is not limited to these specific embodiments, and the present invention includes various aspects without departing from the scope of the invention. Some of the above-described embodiments may be appropriately combined.

For example, the highlight display of the item may be stopped when the eye is not approached, and the highlight display may be resumed when the eye is re-approached. In this case, the layout of the screen may be switched while the highlight display is stopped. In addition, although the example in which the layout of the shooting standby screen is switched according to the orientation change of the digital camera is described, the type of screen and the method of switching the screen are not particularly limited. For example, by maximizing or releasing a screen of an application such as a document creation application or a spreadsheet application, the layout of the screen may be switched. The present invention is also applicable to such layout switching.

Furthermore, in the above-described embodiment, a case where the present invention is applied to the digital camera is described as an example, but the present invention is not limited to the example, and any electronic apparatus (imaging apparatus) capable of performing imaging is applicable. For example, the present invention is applicable to a personal computer, a PDA, a mobile phone terminal, a portable image viewer, a printer apparatus, a digital photo frame, a music player, a video game machine, an electronic book reader, and the like. The present invention is further applicable to, for example, a video player, a display device (including a projector), a tablet terminal, a smartphone, an AI speaker, a home electrical appliance, an on-vehicle apparatus, and the like.

According to the present invention, it is possible for a user to be less likely to miss a part that the user focuses on (pays attention to) in the past.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-027332, filed on Feb. 27, 2024, which is hereby incorporated by reference herein in its entirety.

What is claimed is:

1. An electronic device comprising:
a processor; and
a memory storing a program which, when executed by the processor, causes the electronic device to execute acquisition processing of acquiring information related to a line-of-sight position of a user; and
execute control processing of performing control to display a screen and performing control to identifiably display an item corresponding to a focused position of the user on the screen based on the information related to the line-of-sight position,
wherein, in a case where a layout of the screen is switched, in the control processing, regardless of a focused position of the user on the screen after the switching, control is performed so that an item that is identifiably displayed before the switching is identifiably displayed on the screen after the switching.

2. The electronic device according to claim 1,
wherein the program, when executed by the processor, further causes the electronic device to perform detection processing of detecting an orientation of the electronic device, and
in the control processing, the layout of the screen is switched according to an orientation change of the electronic device from a first orientation to a second orientation.

3. The electronic device according to claim 1,
wherein the focused position is the line-of-sight position.

4. The electronic device according to claim 1,
wherein the focused position is a position where the line-of-sight position is maintained for a predetermined period of time.

5. The electronic device according to claim 1,
wherein the control of identifiably displaying the item includes:
control to enlarge the item;
control to change a color of the item;
control to blink the item, or
control for changing speed of display change of the item.

6. The electronic device according to claim 1,
wherein the control to identifiably display the item is control to display the item that is not displayed.

7. The electronic device according to claim 1,
wherein in the control processing, control is performed so that a first item that is identifiably displayed before the switching is identifiably displayed on the screen after the switching, and a second item corresponding to a new focused position of the user is not identifiably displayed on the screen after the switching.

8. The electronic device according to claim 1,
wherein in the control processing, control is performed so that a first item that is identifiably displayed before the switching is identifiably displayed in a first form on the screen after the switching, and a second item corresponding to a new focused position of the user is identifiably displayed in a second form on the screen after the switching.

9. The electronic device according to claim 1,
wherein, in a case where a size of the item identifiably displayed before the switching on the screen after the switching is smaller than a threshold, the item identifiably displayed before the switching is not identifiably displayed on the screen after the switching.

10. The electronic device according to claim 1,
wherein, in a case where a position corresponding to the item identifiably displayed before the switching on the screen after the switching is within a predetermined area, the item identifiably displayed before the switching is not identifiably displayed on the screen after the switching.

11. The electronic device according to claim 1,
wherein in the control processing, control is performed so that the item is identifiably displayed for a first period of time based on the information relating to the line-of-sight position.

12. The electronic device according to claim 1,
wherein in the control processing, control is performed to identifiably display an item that is identifiably displayed before the switching on the screen after the switching for a second period of time.

13. The electronic device according to claim 1,
wherein the electronic device is an imaging apparatus, and
in a case where the layout of the screen is switched in a state in which an eye is not approached to an eyepiece portion for viewing the screen, in the control processing, after an eye is approached to the eyepiece portion, control is performed so that the item that is identifiably displayed before the switching is identifiably displayed on the screen after the switching for a second period of time.

14. A control method of an electronic device, comprising:
acquiring information related to a line-of-sight position of a user; and
performing control to display a screen and performing control to identifiably display an item corresponding to a focused position of the user on the screen based on the information related to the line-of-sight position,
wherein, in a case where a layout of the screen is switched, regardless of a focused position of the user on the screen after the switching, control is performed so that an item that is identifiably displayed before the switching is identifiably displayed on the screen after the switching.

15. A non-transitory computer readable medium that stores a program, wherein the program causes a computer to execute a control method of an electronic device, the control method comprising:
acquiring information related to a line-of-sight position of a user; and
performing control to display a screen and performing control to identifiably display an item corresponding to a focused position of the user on the screen based on the information related to the line-of-sight position,
wherein, in a case where a layout of the screen is switched, regardless of a focused position of the user on the screen after the switching, control is performed so that an item that is identifiably displayed before the switching is identifiably displayed on the screen after the switching.
